(19) United States
(12) Patent Application Publication
(10) Pub. No.: US 2019/0111391 A1
(43) Pub. Date: Apr. 18, 2019

(54) WET CLEANING APPARATUS AND WET CLEANING METHOD

(71) Applicants: KURITA WATER INDUSTRIES LTD., Tokyo (JP); ASAHI KASEI KABUSHIKI KAISHA, Tokyo (JP)

(72) Inventors: Hideaki IINO, Tokyo (JP); Koji NAKATA, Tokyo (JP); Masayuki KANEDA, Tokyo (JP); Daisuke SATO, Tokyo (JP)

(21) Appl. No.: 16/087,435

(22) PCT Filed: Mar. 24, 2017
(86) PCT No.: PCT/JP2017/011990

§ 371 Date: Sep. 21, 2018

(30) Foreign Application Priority Data
Mar. 25, 2016 (JP) 2016-062178

(51) Int. Cl. B01D 61/14; B01D 71/56; B01D 71/68; B01J 41/07; B01J 41/13; B01J 41/14; B01J 47/12; B01D 61/18; B01D 61/22; B01F 1/00

(52) U.S. Cl. CPC B01D 61/147; B01D 71/56; B01D 71/68; B01J 41/07; B01J 41/13; C02F 1/44; B01J 47/12; B01D 61/18; B01D 61/22; B01F 1/0005; B01F 1/0038; B01J 41/14

(57) ABSTRACT

A wet cleaning apparatus that cleans an item with carbon dioxide gas-dissolved water produced by dissolving carbon dioxide gas in ultrapure water, the wet cleaning apparatus including: a carbon dioxide gas-dissolving unit that dissolves carbon dioxide gas in ultrapure water; a cleaning unit that cleans an item, the cleaning unit receiving carbon dioxide gas-dissolved water fed from the carbon dioxide gas-dissolving unit; and a filtration membrane module disposed on a pipe through which the carbon dioxide gas-dissolved water is fed to the cleaning unit, the filtration membrane module being filled with a porous membrane including a cationic functional group.

### TECHNICAL FIELD

The present invention relates to a wet cleaning apparatus and a wet cleaning method used for cleaning an item with carbon dioxide gas-dissolved water. The present invention relates specifically to a wet cleaning apparatus and a wet cleaning method used in a wet cleaning process performed using carbon dioxide gas-dissolved water in the semiconductor industry, the wet cleaning apparatus and the wet cleaning method being capable of cleaning an item with a high degree of cleanliness by reducing contamination with unwanted microparticles present in the carbon dioxide gas-dissolved water.

### BACKGROUND ART

Since the manufacturing process rules of semiconductor products have been reduced in order to increase the density of ICs, mixing of trace impurities greatly affects the performance and yield of the semiconductor products. In the steps of manufacturing semiconductor products, a strict contamination control has been required for reducing the mixing of trace impurities. Various types of cleaning are performed in the respective steps.

Water containing a dissolved gas such as hydrogen, nitrogen, or ozone and alkalis have been used as various types of functional water for cleaning semiconductor products. As described in, for example, PTL 1, it is becoming common to use carbon dioxide gas-dissolved water (i.e., carbonated water), which is produced by dissolving carbon dioxide gas in ultrapure water, for preventing charging from occurring during cleaning.

In the case where an item is cleaned with carbon dioxide gas-dissolved water, the carbon dioxide gas-dissolved water used for cleaning is likely to contain microparticles as a result of unwanted microparticles generated in a carbon dioxide gas-dissolving device that controls the concentration of carbon dioxide gas entering the water or unwanted microparticles entering the water while ultrapure water fed from an ultrapure water-producing apparatus is transported to a cleaning apparatus through a pipe. As a result, the item cleaned with the water becomes contaminated with the microparticles and a suitable cleaning effect may fail to be achieved.

A known method for reducing contamination by impurities is to arrange a membrane module on a cleaning-water feed pipe included in a cleaning apparatus. For example, PTL 2 proposes a wet cleaning apparatus capable of inhibiting impurities, such as microparticles and heavy metals, which degrade the properties of devices, from adhering onto the surface of a substrate by removing trace impurities, such as heavy metals and colloidal substances, which are present in ultrapure water used as rinsing water in a semiconductor cleaning process. The wet cleaning apparatus includes a porous membrane disposed on a pipe through which hydrogen-containing ultrapure water is transported, the porous membrane including an anion-exchange group, a cation-exchange group, or a chelate-forming group. PTL 3 describes a technique in which ultrapure water used for preparing a cleaning liquid is treated through a porous membrane having an ion-exchange function.

However, in the above patent documents, there is no mention of the removal of microparticles present in carbon dioxide gas-dissolved water.

Although there has been a demand for the removal of ultra-microparticles having a diameter of 20 nm or less and, in particular, 10 nm or less in the field of semiconductor product cleaning, no attempt has been made in the related art to remove even such ultra-microparticles.

In PTLs 4 and 5, polyketone membranes modified with various functional groups are used as a separator membrane included in a capacitor, a battery, or the like. In PTL 5, the polyketone membranes are used also as a filter medium for water treatment. However, in PTLs 4 and 5, there is no mention of the fact that, among the modified polyketone membranes, a polyketone membrane modified with a weakly cationic functional group is particularly effective in removing ultra-microparticles having a diameter of 10 nm or less present in carbon dioxide gas-dissolved water.

PTL 6 describes a porous polyketone membrane that includes one or more functional groups selected from the group consisting of a primary amino group, a secondary amino group, a tertiary amino group, and a quaternary ammonium salt and has an anion-exchange capacity of 0.01 to 10 meq/g. PTL 6 describes that the above porous polyketone membrane can be used in the production of semiconductors and electronic components and in a manufacturing process used in the field of biomedicine, chemistry, food industry, or the like for efficiently removing impurities, such as microparticles, gels, and viruses. It is also suggested in PTL 6 that even 10-nm microparticles and anion particles having a diameter smaller than the pore size of the porous membrane may be removed.

However, it is not described in PTL 6 that the above porous polyketone membrane is effective in removing the ultra-microparticles present in carbon dioxide gas-dissolved water. In PTL 6, it is considered that a strongly cationic quaternary ammonium salt can be also used as a functional group introduced to the porous polyketone membrane similarly to a weakly cationic amino group. The impact of the type of functional group (cation strength) on the removal of ultra-microparticles present in carbon dioxide gas-dissolved water is not studied in PTL 6.

PTL 1: JP 2012-109290 A

PTL 2: JP 2000-228387 A

PTL 3: JP H11-260787 A

PTL 4: JP 2009-286820 A

PTL 5: JP 2013-76024 A

PTL 6: JP 2014-173013 A

### SUMMARY OF INVENTION

An object of the present invention is to provide a wet cleaning apparatus and a wet cleaning method used in a wet cleaning process performed using carbon dioxide gas-dissolved water, the wet cleaning apparatus and the wet cleaning method being capable of cleaning an item with a high degree of cleanliness by removing even ultra-microparticles present in the carbon dioxide gas-dissolved water at a high rejection rate and thereby reducing contamination by the microparticles.

The inventors of the present invention found that ultra-microparticles having a diameter of 50 nm or less or, in particular, 10 nm or less present in carbon dioxide gas-dissolved water can be removed at a high rejection rate by using a porous membrane including a cationic functional group and that the microparticle rejection rate can be further increased when the cationic functional group included in the polyketone membrane is a tertiary amino group.

The summary of the present invention is as follows.

[1] A wet cleaning apparatus that cleans an item with carbon dioxide gas-dissolved water produced by dissolving carbon dioxide gas in ultrapure water, the wet cleaning apparatus comprising a carbon dioxide gas-dissolving unit that dissolves carbon dioxide gas in ultrapure water, a cleaning unit that cleans an item, the cleaning unit receiving carbon dioxide gas-dissolved water fed from the carbon dioxide gas-dissolving unit, and a filtration membrane module disposed on a pipe through which the carbon dioxide gas-dissolved water is fed to the cleaning unit, the filtration membrane module being filled with a porous membrane including a cationic functional group.

[2] The wet cleaning apparatus according to [1], wherein the ultrapure water is fed to the wet cleaning apparatus from an ultrapure water-producing apparatus through an ultrapure-water feed pipe, the ultrapure water-producing apparatus including a primary pure water system and a subsystem.

[3] The wet cleaning apparatus according to [1] or [2], wherein the carbon dioxide gas-dissolving unit is a carbon dioxide gas-dissolving membrane module.

[4] The wet cleaning apparatus according to any one of [1] to [3], wherein the cationic functional group is a weakly cationic functional group.

[5] The wet cleaning apparatus according to [4], wherein the cationic functional group is a tertiary amine group.

[6] The wet cleaning apparatus according to any one of [1] to [5], wherein the cationic functional group is changed into a carbonate-type cationic functional group by substitution.

[7] The wet cleaning apparatus according to any one of [1] to [6], wherein the porous membrane is a microfiltration or ultrafiltration membrane composed of a polymer.

[8] The wet cleaning apparatus according to [7], wherein the porous membrane is any one of a polyketone membrane, a nylon membrane, a polyolefin membrane, and a polysulfone membrane.

[9] The wet cleaning apparatus according to any one of [1] to [8], wherein the porous membrane is capable of rejecting 99% or more of microparticles having a diameter of 10 nm present in the ultrapure water.

[10] A wet cleaning method comprising cleaning an item with carbon dioxide gas-dissolved water by using the wet cleaning apparatus according to any one of [1] to [9].

[11] An apparatus for producing carbon dioxide gas-dissolved water, the apparatus comprising a carbon dioxide gas-dissolving unit that dissolves carbon dioxide gas in ultrapure water, and a filtration membrane module that filters carbon dioxide gas-dissolved water fed from the carbon dioxide gas-dissolving unit, the filtration membrane module being provided with a porous membrane including a cationic functional group.

[12] A method for cleaning an item with carbon dioxide gas-dissolved water, the method comprising filtering the carbon dioxide gas-dissolved water through a porous membrane including a cationic functional group and cleaning an item with the filtered carbon dioxide gas-dissolved water.

[13] A wet cleaning system comprising a carbon dioxide gas-dissolving unit that dissolves carbon dioxide gas in ultrapure water, the ultrapure water being filtrate through an ultrafiltration membrane device included in a subsystem of an ultrapure water-producing apparatus, a filtration membrane module that filters carbon dioxide gas-dissolved water fed from the carbon dioxide gas-dissolving unit, the filtration membrane module being provided with a porous membrane including a cationic functional group, and a cleaning apparatus including a cleaning machine fed with filtrate through the filtration membrane module provided with a porous membrane including a cationic functional group.

[14] The wet cleaning system according to [13], wherein the carbon dioxide gas-dissolving unit is disposed inside the ultrapure water-producing apparatus, the cleaning machine is disposed inside a housing of the cleaning apparatus, and the filtration membrane module filled with a porous membrane including a cationic functional group is disposed inside or outside of the housing.

### Advantageous Effects of Invention

According to the present invention, it is possible to remove even ultra-microparticles present in carbon dioxide gas-dissolved water used for cleaning an item at a high rejection rate. This enables the item to be cleaned with a high degree of cleanliness while reducing contamination by the microparticles.

### BRIEF DESCRIPTION OF DRAWINGS

FIG. 1 is a system diagram illustrating an example of a wet cleaning apparatus and a wet cleaning system according to an embodiment of the present invention.

FIG. 2 is a system diagram illustrating another example of a wet cleaning apparatus and a wet cleaning system according to an embodiment of the present invention.

FIG. 3 is a system diagram illustrating another example of a wet cleaning apparatus and a wet cleaning system according to an embodiment of the present invention.

FIG. 4 is a diagram illustrating an example of the layout of the membrane modules included in a wet cleaning apparatus and a wet cleaning system according to the present invention.

FIG. 5 is a system diagram illustrating a common ultrapure water-producing apparatus and a wet cleaning apparatus.

FIG. 6 is a graph illustrating the detection sensitivity of a microparticle monitor used in Test example 1.

FIGS. 7a and 7b are graphs illustrating the results obtained in Test example 1.

FIG. 8 is a graph illustrating the results obtained in Example 1.

### DESCRIPTION OF EMBODIMENTS

An embodiment of the present invention is described below in detail.

In the present invention, microparticles present in carbon dioxide gas-dissolved water are removed by filtering the carbon dioxide gas-dissolved water through a porous membrane including a cationic functional group.

It has been considered impossible to adsorb microparticles to a membrane modified with a cationic functional group in carbon dioxide gas-dissolved water because, in carbon dioxide gas-dissolved water, the cationic functional group immediately changes into a carbonate-type cationic functional group by substitution and, consequently, adsorption sites are eliminated. It has been also considered that the surfaces of microparticles are positively charged in carbon dioxide gas-dissolved water and charge repulsion occurs on a membrane modified with a cationic functional group, which makes it difficult to remove the microparticles through the membrane.

However, as a result of the studies conducted by the inventors of the present invention, it was found that microparticles present in carbon dioxide gas-dissolved water can be removed at a high rejection rate by using a porous membrane including a cationic functional group.

While the mechanisms by which microparticles are removed through such a porous membrane are uncertain, it is considered that microparticles are removed through the membrane by the following mechanisms.

Microparticles present in carbon dioxide gas-dissolved water are more stable when adsorbed on a porous membrane including a cationic functional group at multiple points than when subjected to carbon dioxide gas-dissolved water, which is a carbon dioxide-rich environment, while the carbon dioxide gas adsorbed on the cationic functional group is likely to diffuse into carbon dioxide gas-dissolved water passed through the membrane. This enables microparticles present in carbon dioxide gas-dissolved water to be removed at a high rejection rate by using a porous membrane including a cationic functional group.

[Carbon Dioxide Gas-Dissolved Water]

The carbon dioxide gas-dissolved water used for cleaning an item varies also with the purpose of cleaning. Carbon dioxide gas-dissolved water is commonly used as rinsing water for rinsing semiconductor products, such as silicon wafers, after the products have been cleaned with chemicals. The concentration of carbon dioxide gas in the carbon dioxide gas-dissolved water used as rinsing water is preferably about 5 to 200 mg/L.

The temperature of the carbon dioxide gas-dissolved water is not limited; the carbon dioxide gas-dissolved water may have a normal temperature of about 20° C. or may be heated to about 60° C. to 80° C.

The carbon dioxide gas-dissolving unit used for producing the carbon dioxide gas-dissolved water is not limited but preferably a carbon dioxide gas-dissolving membrane module.

The cleaning chemical, ultrapure water, and functional water used prior to the cleaning using the carbon dioxide gas-dissolved water are not limited.

[Porous Membrane Including Cationic Functional Group]

The cationic functional group included in the porous membrane including a cationic functional group is preferably a weakly cationic functional group, because weakly cationic functional groups have higher stability than strongly cationic functional groups. Strongly cationic functional groups are not preferable because they disadvantageously increase the amount of TOC components contained in the permeate by desorption. In the present invention, a porous membrane including a weakly cationic functional group is preferably used.

Examples of the weakly cationic functional group include a primary amino group, a secondary amino group, and a tertiary amino group. The porous membrane may include only one of the above weakly cationic functional groups. The porous membrane may include two or more of the above weakly cationic functional groups.

Among the above weakly cationic functional groups, a tertiary amino group is preferable since it has a strong cationic property and is chemically stable.

While a quaternary ammonium salt is considered in the same bracket as a tertiary amino group in PTL 6 as described above, a quaternary ammonium group is not preferable because it is a strongly cationic functional group and poor in chemical stability and may contaminate the ultrapure water by desorption.

It is not necessary to introduce a strongly cationic functional group to the porous membrane in order to remove weakly anionic ionic substances, such as silica and boron, contained in the water because these substances can be removed principally using a strongly anion-exchange resin included in a subsystem of an ultrapure water-producing apparatus and are not the substances that are to be removed in the present invention.

The chemical stability of an amino group and the chemical stability of an ammonium group, which are cationic functional groups, in an anion-exchange resin have been described in terms of service temperature limit; the service temperature limit of an OH-type strong anion-exchange resin including a quaternary ammonium group is 60° C. or less, while the service temperature limit of a weak anion-exchange resin including a tertiary amino group is 100° C. or less (DIAION 2 Manual of Ion Exchange Resins and Synthesis Adsorbent, Mitsubishi Chemical Corporation, II-4, DIAION 2 Manual of Ion Exchange Resins and Synthesis Adsorbent, Mitsubishi Chemical Corporation, II-8). Furthermore, the properties of a strong anion-exchange resin become degraded with time. Specifically, the salt splitting capacity of a strong anion-exchange resin changes more rapidly than the total ion-exchange capacity of the strong anion-exchange resin. This means that a quaternary ammonium group changes into a tertiary amino group as a result of an alkyl group desorbing from the quaternary ammonium group (DIAION 1 Manual of Ion Exchange Resins and Synthesis Adsorbent, Mitsubishi Chemical Corporation, pp. 92-93).

For the above reasons, in the present invention, a porous membrane including a weakly cationic functional group, such as a tertiary amino group, is preferably used. The porous membrane is preferably a microfiltration (MF) membrane or an ultrafiltration (UF) membrane in order to maintain a microparticle-capturing capability and to control the pressure loss during cleaning.

The cationic functional group included in the porous membrane including a cationic functional group changes into a carbonate type cationic functional group by substitution when the porous membrane is used for treating the carbon dioxide gas-dissolved water. Microparticles capable of multi-point adsorption have a larger capacity to adsorb to a cationic functional group than carbon dioxide gas even when the cationic functional group is a carbonate-type cationic functional group. In addition, carbon dioxide gas adsorbed on the membrane is likely to diffuse into the gas-dissolved water passed through the membrane. Consequently, the carbonate-type cationic functional group has a microparticle rejection capability comparable to that of an unsubstituted cationic functional group.

The material for the porous membrane is not limited; the porous membrane may be composed of any material that includes a cationic functional group. Examples of the porous membrane include a polyketone membrane, a mixed cellulose ester membrane, a polyolefin membrane composed of polyethylene or the like, a polysulfone membrane, a polyethersulfone membrane, a polyvinylidene fluoride membrane, a polytetrafluoroethylene membrane, and a nylon membrane. The porous membrane is preferably a polyketone membrane, a nylon membrane, a polyolefin membrane, or a polysulfone membrane. Commercially available examples of the above membranes include Posidyne (Pall Corporation) and LifeAssure (The 3M Company) that include a quaternary cationic functional group.

Among the above membranes, a polyketone membrane is preferable because it has a large surface aperture ratio, which allows a high flux to be achieved even at a low pressure, and a cationic functional group can be more easily introduced into the porous membrane by chemical modification when the porous membrane is a polyketone membrane.

The polyketone membrane is a porous polyketone membrane including 10% to 100% by mass polyketone that is a copolymer of carbon monoxide with one or more olefins and can be prepared by a publicly known method (e.g., JP 2013-76024 A or WO 2013-035747 A).

Since the MF or UF membrane including a cationic functional group captures and removes microparticles present in the carbon dioxide gas-dissolved water due to its electric adsorption capacity, the pore size of the MF or UF membrane may be larger than the diameter of the microparticles that are to be removed. However, if the pore size of the membrane is excessively large, the efficiency with which the membrane rejects the microparticles is low. On the other hand, if the pore size of the membrane is excessively small, a high pressure is required for the membrane filtration. In the case where the porous membrane is an MF membrane, an MF membrane having a pore size of about 0.05 to 0.2 μm is preferably used. In the case where the porous membrane is a UF membrane, a UF membrane having a cut-off molecular weight of about 5000 to 1 million is preferably used.

The shape of the MF or UF membrane is not limited; membranes commonly used in the field of ultrapure water production, such as a hollow fiber membrane and a flat membrane, may be used.

The cationic functional group may be introduced directly to a component of the MF or UF membrane, such as a polyketone membrane, by chemical modification. Alternatively, the cationic functional group may be introduced to the MF or UF membrane as a result of a compound or ion-exchange resin that includes a cationic functional group being supported on the MF or UF membrane.

Examples of the method for producing the porous membrane including a cationic functional group include, but are not limited to, the following methods 1) to 6). These methods may be implemented in combination of two or more.

1) Introduce a cationic functional group directly to a porous membrane by chemical modification.

One of the methods for introducing a weakly cationic amino group to a polyketone membrane by chemical modification is to cause a chemical reaction with a primary amine. Multifunctional amines, such as diamine, triamine, tetraamine, and polyethyleneimine, that include a primary amine, such as ethylenediamine, 1,3-propanediamine, 1,4-butanediamine, 1,2-cyclohexanediamine, N-methylethylenediamine, N-methylpropanediamine, N,N-dimethylethylenediamine, N,N-dimethylpropanediamine, N-acetylethylenediamine, isophoronediamine, and N,N-dimethylamino-1,3-propanediamine, are preferable because they are capable of introducing a number of active spots to the porous membrane. In particular, it is more preferable to use N,N-dimethylethylenediamine, N,N-dimethylpropanediamine, N,N-dimethylamino-1,3-propanediamine, or polyethyleneimine because they are capable of introducing a tertiary amine to the porous membrane.

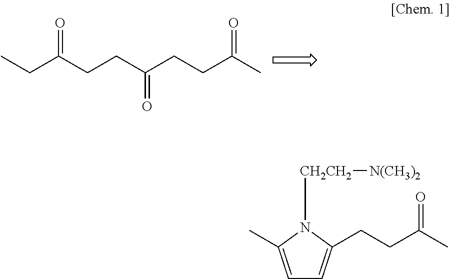

2) Interpose a weak anion-exchange resin (i.e., a resin including a weakly cationic functional group) between two porous membranes after the resin has been crushed as needed.

3) Fill the inside of the porous membrane with microparticles of a weak anion-exchange resin. For example, a porous membrane including particles of a weak anion-exchange resin may be formed by adding the weak anion-exchange resin to a solution used for forming the porous membrane.

4) Deposit or apply a compound including a weakly cationic functional group, such as tertiary amine, onto a porous membrane by immersing the porous membrane in a solution of tertiary amine or passing a solution of tertiary amine through the porous membrane. Examples of the compound including a weakly cationic functional group, such as tertiary amine, include N,N-dimethylethylenediamine, N,N-dimethylpropanediamine, N,N-dimethylamino-1,3-propanediamine, polyethyleneimine, an amino group-containing poly(meth)acrylic acid ester, and amino group-containing poly(meth)acrylamide.

5) Introduce a weakly cationic functional group, such as a tertiary amino group, into a porous membrane, such as a porous polyethylene membrane, by graft polymerization.

6) Produce a porous membrane including a weakly cationic functional group, such as a tertiary amino group, by polymerizing a styrene monomer including a halogenated alkyl group after the halogenated alkyl group has been replaced with a weakly cationic functional group, such as a tertiary amino group, and forming the resulting polymer into a membrane by phase separation or electrospinning.

The porous membrane including a cationic functional group which is used in the present invention is preferably capable of rejecting 99% or more of microparticles having a diameter of 10 nm present in ultrapure water as described in Test example 1 below.

The conditions under which the carbon dioxide gas-dissolved water is treated through a filtration membrane module provided with the porous membrane including a cationic functional group in order to remove the microparticles present in the carbon dioxide gas-dissolved water may be set appropriately. The flow rate through the membrane module is 0.1 to 100 L/min and is preferably 0.5 to 50 L/min. The pressure difference (ΔP) across the membrane module is preferably set to 1 to 200 kPa.

[Wet Cleaning Apparatus and Wet Cleaning System]

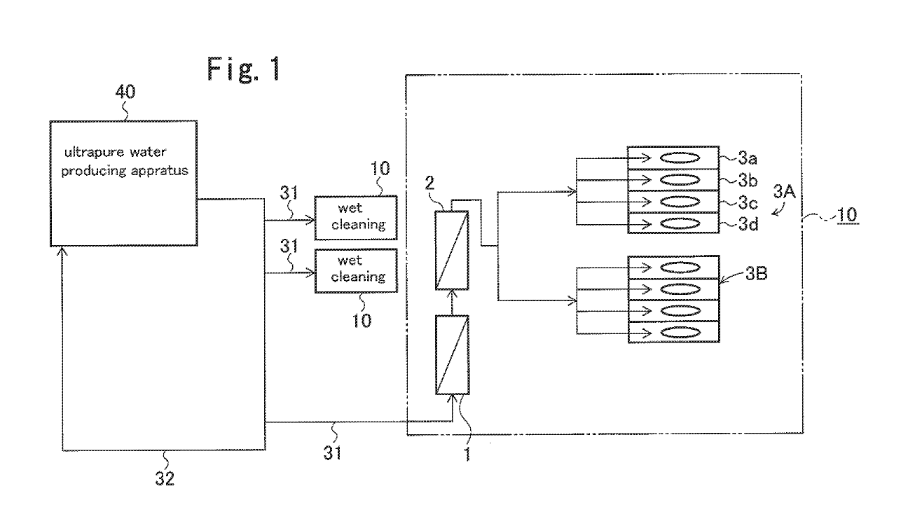

A wet cleaning apparatus and a wet cleaning system according to the present invention are described below with reference to FIGS. 1 to 5.

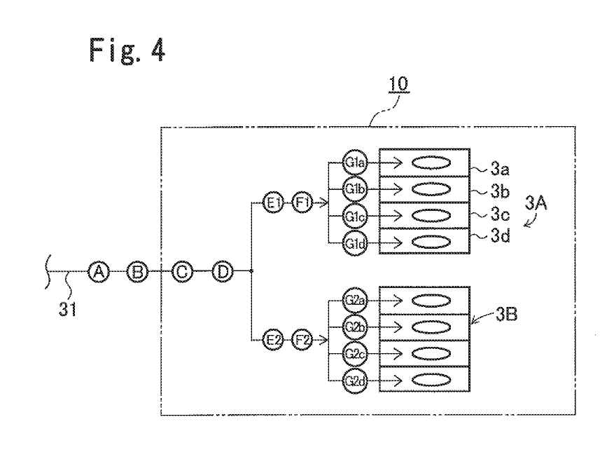

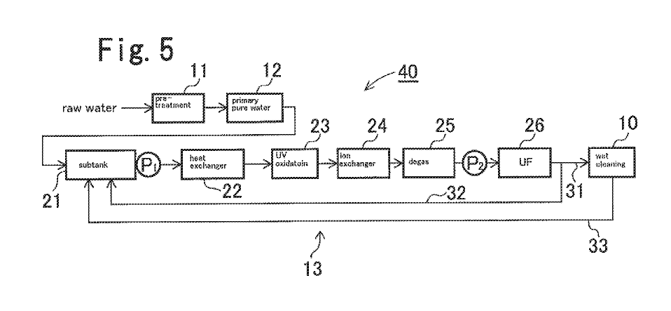

FIGS. 1 to 3 are system diagrams illustrating an example of the wet cleaning apparatus and the wet cleaning system according to the present invention. FIG. 4 is a diagram illustrating an example of the layout of the membrane modules. FIG. 5 is a system diagram illustrating the wet cleaning apparatus and an ultrapure water-producing apparatus with which ultrapure water is fed to the wet cleaning apparatus. In FIGS. 1 to 5, elements having the same function are denoted by the same reference numeral.

In FIGS. 1 to 4, ultrapure water produced in an ultrapure water-producing apparatus 40 is fed to wet cleaning apparatuses 10 through a circulation pipe 32 and branch pipes 31. Each of the wet cleaning apparatuses includes a plurality of cleaning machines 3A and 3B arranged in parallel to one another. Each of the cleaning machines 3A and 3B includes a plurality of cleaning chambers 3a, 3b, 3c, and 3d arranged in parallel to one another, which are used for cleaning an item. The number of the cleaning machines included in each of the wet cleaning apparatuses 10 is not limited to the number of the cleaning machines illustrated in the drawings. The number of the cleaning chambers included in each of the cleaning machines is not limited to the number of the cleaning chambers illustrated in the drawings. For example, the number of cleaning machines may be appropriately selected from 2 to 10. The number of cleaning chambers included in each cleaning machine may be appropriately selected from 2 to 10.

Each of the wet cleaning apparatuses 10 illustrated in FIGS. 1 to 4 includes a carbon dioxide gas-dissolving membrane module 1 that dissolves carbon dioxide gas in ultrapure water fed from the ultrapure water-producing apparatus 40 and a filtration membrane module (hereinafter, may be referred to as “microparticle removal membrane module”) 2 disposed downstream of the carbon dioxide gas-dissolving membrane module 1. The filtration membrane module is filled with a porous membrane including a cationic functional group. Carbon dioxide gas-dissolved water produced in the carbon dioxide gas-dissolving membrane module 1 by dissolving carbon dioxide gas in the ultrapure water is fed to the microparticle removal membrane module 2, in which microparticles are removed from the carbon dioxide gas-dissolved water. The carbon dioxide gas-dissolved water is subsequently fed to the cleaning chambers 3a to 3d included in each of the cleaning machines 3A and 3B, in which an item, such as a silicon wafer, is cleaned.

The carbon dioxide gas-dissolving membrane module 1 and the microparticle removal membrane module 2 may be included in the same housing (denoted by the dashed line in FIG. 1) as the cleaning machines 3A and 3B. The carbon dioxide gas-dissolving membrane module 1 and/or the microparticle removal membrane module 2 may be disposed outside the housing and connected to one another with a pipe.

FIG. 5 illustrates a case where ultrapure water produced in an ultrapure water-producing apparatus 40 including a pre-treatment system 11, a primary pure water system 12, and a subsystem 13 is fed to the wet cleaning apparatus 10 according to the present invention illustrated in FIG. 1, in which carbon dioxide gas-dissolved water is produced from the ultrapure water and used for cleaning after microparticles have been removed from the carbon dioxide gas-dissolved water.

The pre-treatment system 11 including a coagulation device, a dissolved-air flotation (sedimentation) device, a filtration device, etc. removes suspended solids and colloidal substances present in raw water. The primary pure water system 12 including a reverse osmosis (RO) membrane separation device, a degassing device, and an ion-exchange device (a mixed-bed, two-bed-three-tower, or four-bed-five-tower ion-exchange device) removes ions and organic components present in raw water. The RO-membrane separation device removes salts and ionic, neutral, and colloidal TOC components. The ion-exchange device removes salts and TOC components that can be adsorbed to an ion-exchange resin or ion-exchanged with an ion-exchange resin. The degassing device (nitrogen degassing or vacuum degassing) removes dissolved oxygen (DO).

Primary pure water (normally, pure water having a TOC concentration of 2 ppb or less) produced in the above manner is passed through a subtank 21, a pump P₁, a heat exchanger 22, a UV oxidation device 23, a mixed-bed ion-exchange device 24, a degassing device 25, a pump P₂, and a microparticle-separation UF membrane device 26 sequentially in this order. The resulting ultrapure water (normally, ultrapure water having a TOC concentration of 1000 ppt or less) is transported to the wet cleaning apparatus 10 according to the present invention, which is the point-of-use.

The UV oxidation device 23 is preferably a UV oxidation device capable of emitting UV radiation having a wavelength of about 185 nm, which is used in ultrapure water-producing apparatuses and is, for example, a UV oxidation device that includes a low-pressure mercury lamp. The UV oxidation device 23 decomposes the TOC components present in the primary pure water into organic acids and, finally, CO₂.

The water treated by the UV oxidation device 23 is passed into the mixed-bed ion-exchange device 24. The mixed-bed ion-exchange device 24 is preferably a nonregenerative mixed-bed ion-exchange device filled with an anion-exchange resin and a cation-exchange resin that are mixed with each other in accordance with ionic loads. The mixed-bed ion-exchange device 24 removes cations and anions present in the water and increases the purity of the water.

The water treated by the mixed-bed ion-exchange device 24 is passed into the degassing device 25. The degassing device 25 is preferably a vacuum degassing device, a nitrogen degassing device, or a membrane degassing device. The degassing device 25 efficiently removes DO and CO₂ present in the water.

The water treated by the degassing device 25 is passed into the UF membrane device 26 with the pump P₂. The UF membrane device 26 removes microparticles present in the water, such as microparticles of an ion-exchange resin discharged from the mixed-bed ion-exchange device 25.

A required amount of the ultrapure water produced in the UF membrane device 26 is fed to wet cleaning apparatus 10 through a pipe 31, while the excess water is returned to the subtank 21 through a pipe 32. Part of the ultrapure water which has not been used in the wet cleaning apparatus 10 is returned to the subtank 21 through a pipe 33.

The length of the ultrapure-water feed pipe that extends from the UF membrane device 26, which is the last one of the devices constituting the subsystem 13 of the ultrapure water-producing apparatus, to the wet cleaning apparatus 10 is commonly 10 m or more and, in many cases, 20 m or more. There are not a few cases where the length of the ultrapure-water feed pipe is 100 m or more. While the ultrapure water is transported through such a long pipe, microparticles may again enter the ultrapure water as a result of production of dust particles although microparticles present in the ultrapure water have been removed in the UF membrane device.

The microparticles present in the ultrapure water may be removed by arranging a microparticle removal membrane module upstream of the carbon dioxide gas-dissolving membrane module 1. In such a case, however, it is not possible to prevent the water from becoming contaminated by the microparticles generated in the carbon dioxide gas-dissolving membrane module 1.

Since the wet cleaning apparatus and wet cleaning system according to the present invention includes the microparticle removal membrane module 2 disposed downstream of the carbon dioxide gas-dissolving membrane module 1, it is possible to reduce contamination by microparticles generated in the carbon dioxide gas-dissolving membrane module 1 as well as the contamination by the microparticles generated during the transportation of the ultrapure water.

Some ultrapure water-producing apparatuses produce carbon dioxide gas-dissolved water inside the apparatus and feed the carbon dioxide gas-dissolved water to a wet cleaning apparatus through the pipe 32. In such cases, the microparticles can be removed in the microparticle removal membrane module included in the wet cleaning apparatus. In this case, the wet cleaning apparatus does not necessarily include the carbon dioxide gas-dissolving membrane module. The microparticle removal membrane module may be disposed either inside or outside the housing of the wet cleaning apparatus.

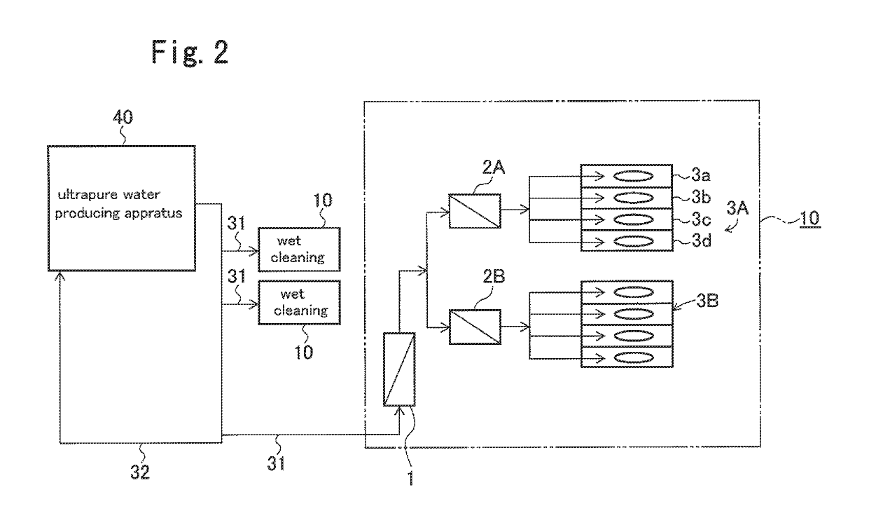

FIG. 2 illustrates a wet cleaning apparatus that includes, instead of the microparticle removal membrane module 2, microparticle removal membrane modules 2A and 2B disposed on the branch pipes through which the carbon dioxide gas-dissolved water is fed to the cleaning machines 3A and 3B, respectively. The other members illustrated in FIG. 2 are the same as those included in the wet cleaning apparatus illustrated in FIG. 1. The microparticle removal membrane modules may alternatively be disposed on the respective branch pipes through which the carbon dioxide gas-dissolved water is fed to the cleaning chambers 3a to 3d of each of the cleaning machines 3A and 3B.

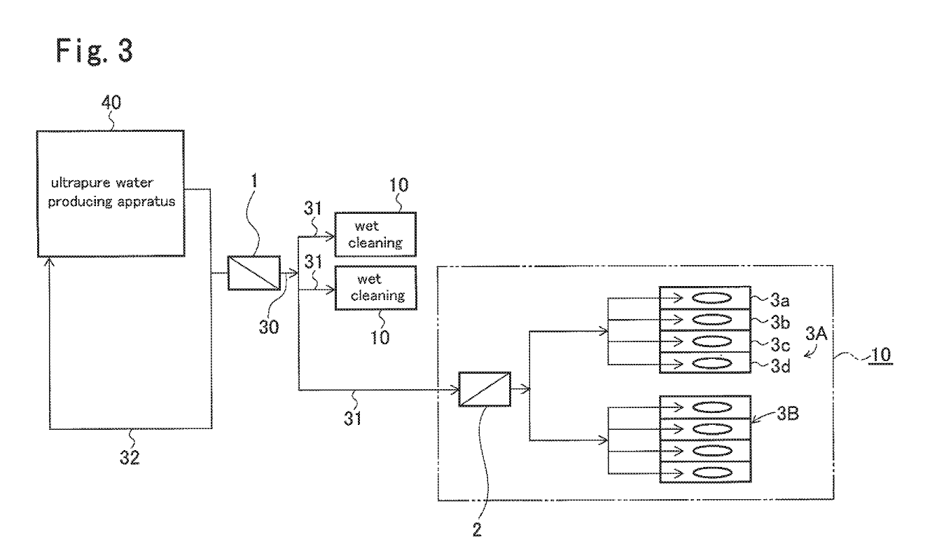

FIG. 3 illustrates a wet cleaning apparatus that includes the carbon dioxide gas-dissolving membrane module 1 disposed on a pipe 30 branched from the ultrapure water circulation pipe 32 of the ultrapure water-producing apparatus 40 and the microparticle removal membrane module 2 disposed inside the housing of each of the wet cleaning apparatuses 10.

As described above, in the present invention, the microparticle removal membrane module is disposed downstream of the carbon dioxide gas-dissolving membrane module and the filtrate through the microparticle removal membrane module is fed to the cleaning machines. Examples of the layout of the carbon dioxide gas-dissolving membrane module and the microparticle removal membrane module include the following i) to iv).

i) Arrange the carbon dioxide gas-dissolving membrane module downstream of the UF membrane device included in the ultrapure water-producing apparatus and the microparticle removal membrane module at the position B, the position D, the positions F1 and F2, or the positions G1a to G1d and G2a to G2d illustrated in FIG. 4.

ii) Arrange the carbon dioxide gas-dissolving membrane module at the position A illustrated in FIG. 4 and the microparticle removal membrane module at the position B, the position D, the positions F1 and F2, or the positions G1a to G1d and G2a to G2d illustrated in FIG. 4.

iii) Arrange the carbon dioxide gas-dissolving membrane module at the position C illustrated in FIG. 4 and the microparticle removal membrane module at the position D, the positions F1 and F2, or the positions G1a to G1d and G2a to G2d illustrated in FIG. 4.

iv) Arrange the carbon dioxide gas-dissolving membrane module at the positions E1 to E4 illustrated in FIG. 4 and the microparticle removal membrane module at the positions F1 and F2 or the positions G1a to G1d and G2a to G2d illustrated in FIG. 4.

In any of the above cases, the microparticle removal membrane module is disposed downstream of the carbon dioxide gas-dissolving membrane module. This reduces the contamination by the microparticles generated in the carbon dioxide gas-dissolving membrane module 1 as well as the contamination by the microparticles generated during the transportation.

The microparticle removal membrane module may be disposed at two or more positions selected from the position B, the position D, the positions F1 and F2, and the positions G1a to G1d and G2a to G2d. The closer to the cleaning machines the position of the microparticle removal membrane module, the larger the reduction in the degree of contamination by the microparticles generated while the carbon dioxide gas-dissolved water passes through the pipe. However, arranging the microparticle removal membrane module on, for example, the branch pipes is not preferable in terms of cost, because this increases the number of the microparticle removal membrane modules required.

The cleaning machines (i.e., cleaning units) are not limited and may be either a single-wafer cleaning machine or a batch-tank cleaning machine.

The wet cleaning apparatus according to the present invention may include, in addition to the microparticle removal membrane module that is a filtration membrane module filled with the porous membrane including a cationic functional group, a catalytic resin column disposed upstream of the microparticle removal membrane module, which is capable of removing oxidizing components in order to remove oxidizing substances and the microparticles simultaneously.

An example of a wet cleaning apparatus in which the above membrane modules are used in combination with other membrane modules is a wet cleaning apparatus that includes a UF membrane module, a heavy-metal removal membrane module (e.g., Protego C F (produced by Entegris, Inc.)), a carbon dioxide gas-dissolving membrane module, and the microparticle removal membrane module according to the present invention that are arranged in this order.

### EXAMPLES

The present invention is described below more specifically with reference to Test example and Example.

The following filtration membranes were used in Test example and Example.

Filtration membrane I (for the present invention): Polyketone MF membrane (area: 0.13 m²) having a pore size of 0.1 μm to which a dimethylamino group had been introduced by immersing a polyketone membrane produced by a publicly known method (e.g., JP 2013-76024 A or WO 2013-035747 A) in an aqueous N,N-dimethylamino-1,3-propylamine solution containing a small amount of acid, subsequently heating the polyketone membrane, then cleaning the polyketone membrane with water and methanol, and further drying the polyketone membrane.

Filtration membrane II (for comparison): Commercially available pleated polyarylsulfone membrane (area: 0.25 m²) having a nominal pore size of 5 nm.

### Test Example 1

The microparticle rejection capabilities of the filtration membranes I and II were determined by conducting a test using online microparticle monitors “LiquiTrac Scanning TPC1000” produced by Fluid Measurement Technologies, Inc. (capable of measuring 10-nm microparticles; hereinafter, referred to as “microparticle monitor “TPC1000”) which were disposed downstream of the respective filtration membranes.

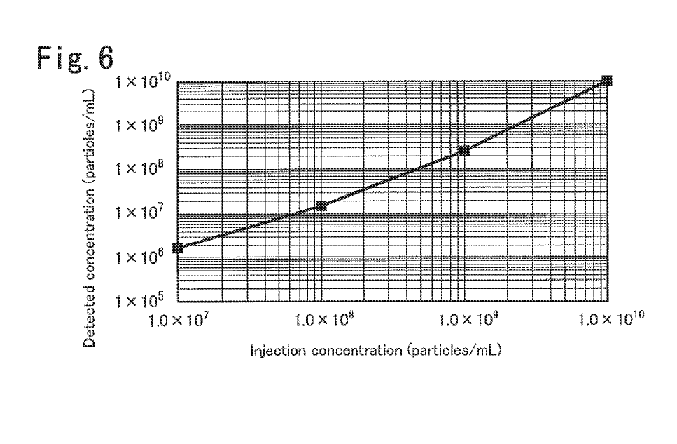

A dispersion containing 10-nm silica particles produced by Sigma-Aldrich was added to ultrapure water with a syringe pump. The concentration of the microparticles in the dispersion was adjusted to be 1×10⁷ to 1×10⁹ particles/mL. This dispersion was used as a test liquid. The test liquid was directly introduced to the microparticle monitor “TPC1000” without being passed through the membrane in order to determine the sensitivity with which the microparticle monitor detected the microparticles. FIG. 6 illustrates the results. It was confirmed that the microparticle monitor was capable of detecting silica microparticles having a particle diameter of 10 nm with high sensitivity.

The test liquid was filtered through each of the filtration membranes I and II at a filtration rate of 0.5 L/min and a pressure difference (ΔP) of 10 kPa.

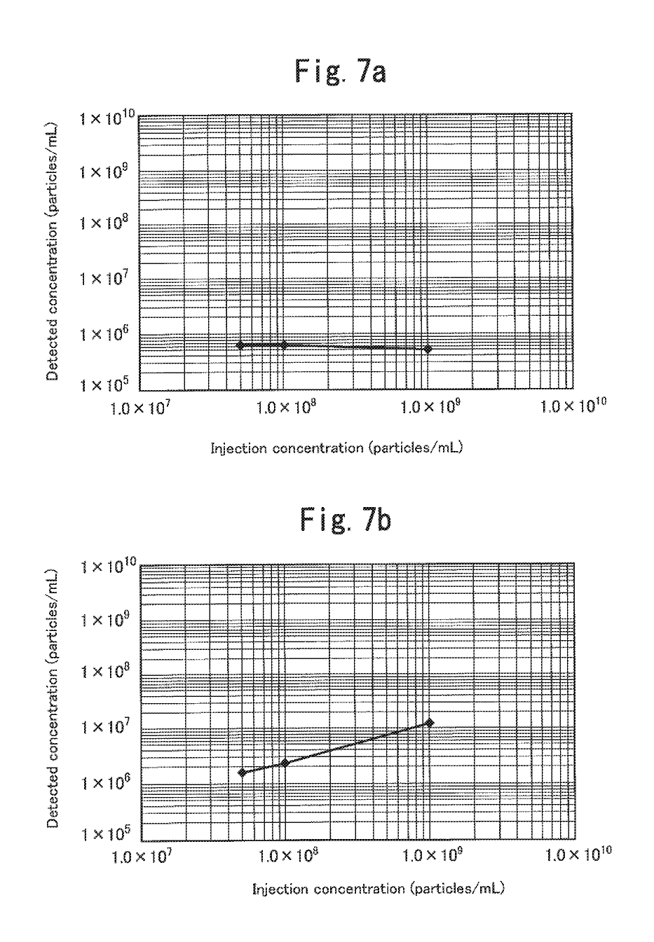

FIGS. 7a and 7b illustrate the microparticle rejection capabilities of the filtration membranes I and II, respectively (i.e., the relationships between the injection concentration of the microparticles and the detected concentration of the microparticles in the filtrate).

The results illustrated in FIGS. 7a and 7b confirm that the filtration membrane I had a larger microparticle rejection capability than the filtration membrane II and was capable of reducing the concentration of silica microparticles having a diameter of 10 nm from 1×10⁷ to 1×10⁹ particles/mL to 1×10⁶ particles/mL or less, that is, to a concentration equal to or less than the detection limit (i.e., a rejection rate of 99.9% or more). In contrast, the filtration membrane II had a significantly low microparticle rejection capability.

### Example 1

A carbon dioxide gas-dissolving membrane module (“Liqui-Cel” produced by Asahi Kasei Corporation) was disposed on an ultrapure-water feed line. Carbon dioxide gas-dissolved water having a carbon dioxide gas concentration of 20 or 40 mg/L was prepared. A dispersion of 20-nm silica particles produced by Sigma-Aldrich was added to the carbon dioxide gas-dissolved water with a syringe pump such that the concentration of the microparticles was 2×10⁵ or 2×10⁹ particles/mL. Hereby, a test liquid was prepared.

The test liquid was filtered through the filtration membrane I at a flow rate of 75 or 750 mL/min (pressure difference ΔP: 1 or 10 kPa). The microparticle rejection capability of the filtration membrane I was determined using an online microparticle monitor “Ultra DI 20” (capable of measuring 20-nm microparticles) produced by Particle Measuring Systems which was disposed downstream of the filtration membrane I.

The test was conducted in a continuous manner while the concentrations of carbon dioxide gas and silica microparticles in the test liquid and the flow rate of the test liquid were changed in each Run as described below.

Run 1: carbon dioxide gas: 20 mg/L (no injection of silica microparticles, no filtration), flow rate: 75 mL/min

Run 2: carbon dioxide gas: 20 mg/L, silica: 2×10⁵ particles/mL (no filtration), flow rate: 75 mL/min

Run 3: carbon dioxide gas: 20 mg/L, silica: 2×10⁵ particles/mL, filtration: 75 mL/min

Run 4: carbon dioxide gas: 20 mg/L, silica: 2×10⁹ particles/mL, filtration: 75 mL/min

Run 5: carbon dioxide gas: 40 mg/L, silica: 2×10⁹ particles/mL, filtration: 75 mL/min

Run 6: carbon dioxide gas: 40 mg/L, silica: 2×10⁹ particles/mL, filtration: 750 mL/min

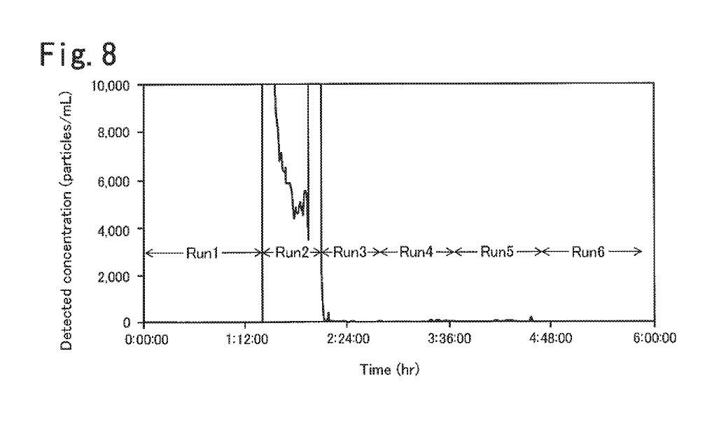

FIG. 8 illustrates the results.

The results illustrated in FIG. 8 confirm that the microparticles present in the carbon dioxide gas-dissolved water could be removed at a high rejection rate through the filtration membrane I regardless of the changes in the concentrations of carbon dioxide gas and microparticles and flow rate.

Although the present invention has been described in detail with reference to particular embodiments, it is apparent to a person skilled in the art that various modifications can be made therein without departing from the spirit and scope of the present invention.

The present application is based on Japanese Patent Application No. 2016-062178 filed on Mar. 25, 2016, which is incorporated herein by reference in its entirety.

### REFERENCE SIGNS LIST

1 CARBON DIOXIDE GAS-DISSOLVING MEMBRANE MODULE
2, 2A, 2B MICROPARTICLE REMOVAL MEMBRANE MODULE
3A, 3B CLEANING MACHINE
3a, 3b, 3c, 3d CLEANING CHAMBER
11 PRE-TREATMENT SYSTEM
12 PRIMARY PURE WATER SYSTEM
13 SUBSYSTEM
10 WET CLEANING APPARATUS
40 ULTRAPURE WATER-PRODUCING APPARATUS

1. A wet cleaning apparatus that cleans an item with carbon dioxide gas-dissolved water produced by dissolving carbon dioxide gas in ultrapure water, the wet cleaning apparatus comprising:
a carbon dioxide gas-dissolving unit that dissolves carbon dioxide gas in ultrapure water;
a cleaning unit that cleans an item, the cleaning unit receiving carbon dioxide gas-dissolved water fed from the carbon dioxide gas-dissolving unit; and
a filtration membrane module disposed on a pipe through which the carbon dioxide gas-dissolved water is fed to the cleaning unit, the filtration membrane module being filled with a porous membrane including a cationic functional group.

2. The wet cleaning apparatus according to claim 1, wherein the ultrapure water is fed to the wet cleaning apparatus from an ultrapure water-producing apparatus through an ultrapure-water feed pipe, the ultrapure water-producing apparatus including a primary pure water system and a subsystem.

3. The wet cleaning apparatus according to claim 1, wherein the carbon dioxide gas-dissolving unit is a carbon dioxide gas-dissolving membrane module.

4. The wet cleaning apparatus according to claim 1, wherein the cationic functional group is a weakly cationic functional group.

5. The wet cleaning apparatus according to claim 4, wherein the cationic functional group is a tertiary amine group.

6. The wet cleaning apparatus according to claim 1, wherein the cationic functional group is changed into a carbonate-type cationic functional group by substitution.

7. The wet cleaning apparatus according to claim 1, wherein the porous membrane is a microfiltration or ultrafiltration membrane composed of a polymer.

8. The wet cleaning apparatus according to claim 7, wherein the porous membrane is any one of a polyketone membrane, a nylon membrane, a polyolefin membrane, and a polysulfone membrane.

9. The wet cleaning apparatus according to claim 1, wherein the porous membrane is capable of rejecting 99% or more of microparticles having a diameter of 10 nm present in the ultrapure water.

10. A wet cleaning method comprising cleaning an item with carbon dioxide gas-dissolved water by using the wet cleaning apparatus according to claim 1.

11. An apparatus for producing carbon dioxide gas-dissolved water, the apparatus comprising:
a carbon dioxide gas-dissolving unit that dissolves carbon dioxide gas in ultrapure water; and
a filtration membrane module that filters carbon dioxide gas-dissolved water fed from the carbon dioxide gas-dissolving unit, the filtration membrane module being provided with a porous membrane including a cationic functional group.

12. A method for cleaning an item with carbon dioxide gas-dissolved water, the method comprising:
filtering the carbon dioxide gas-dissolved water through a porous membrane including a cationic functional group; and
cleaning an item with the filtered carbon dioxide gas-dissolved water.

13. A wet cleaning system comprising:
a carbon dioxide gas-dissolving unit that dissolves carbon dioxide gas in ultrapure water, the ultrapure water being filtrate through an ultrafiltration membrane device included in a subsystem of an ultrapure water-producing apparatus;
a filtration membrane module that filters carbon dioxide gas-dissolved water fed from the carbon dioxide gas-dissolving unit, the filtration membrane module being provided with a porous membrane including a cationic functional group; and
a cleaning apparatus including a cleaning machine fed with filtrate through the filtration membrane module provided with a porous membrane including a cationic functional group.

14. The wet cleaning system according to claim 13, wherein the carbon dioxide gas-dissolving unit is disposed inside the ultrapure water-producing apparatus, the cleaning machine is disposed inside a housing of the cleaning apparatus, and the filtration membrane module filled with a porous membrane including a cationic functional group is disposed inside or outside of the housing.
